(19) United States
(12) Patent Application Publication
(10) Pub. No.: US 2006/0129420 A1
(43) Pub. Date: Jun. 15, 2006

(54) Method providing asset protection by specifying location, recipients of information and terms for the release of information

(76) Inventor: Nicholas Pisano, Marco Island, FL (US)

Correspondence Address: Mr. Nicholas Pisano, 750 Pelican Court, Marco Island, FL, 34145, US

(21) Appl. No.: 11/292,822

(22) Filed: Dec. 2, 2005

Related U.S. Application Data
(60) Provisional application No. 60/634,008, filed on Dec. 7, 2004.

(51) Int. Cl. G06Q 99/00

(52) U.S. Cl. 705/1

(57) ABSTRACT

The invention provides a system and method for individuals to protect their assets and important documents. The method includes a safe keeping institution providing three forms for the user to complete and return. One form entitled “Location” allows the individual to record the location of the individual's assets and important documents without identifying the particular assets or important documents nor its monetary value. The location indicated on the Location Form is to be described in general terms but sufficient so that any person of ordinary skill can, with the required authority or by operation of law, ascertain what the asset or important document is at that location. One form entitled “Recipients” requires one or more individual's name, address and hand written signature. One form entitled “Release of Information” identifies the conditions upon which the information listed on the Location Form can be released to the recipient. Upon written request from a designated recipient and knowledge that the member's predetermined conditions have been met, the recipient is provided a copy of the member's Location Form.

### CROSS-REFERENCE TO RELATED APPLICATIONS

This application claims the benefit of provisional patent application Ser. No. 60/634,008, filed Dec. 7, 2004, which is hereby incorporated by reference.

### FEDERALLY SPONSORED RESEARCH

Not Applicable

### SEQUENCE LISTING OR PROGRAM

Not Applicable

### BACKGROUND OF THE INVENTION

1. Field of Invention

This invention provides a member with the means of protecting one's assets and important documents. It provides a central depository herein described as Safe Keeping Institution to administer and store information regarding assets and important documents by a method and use of the following forms:
A form herein referred to as “Location” form to record location of assets and important documents.
A form herein referred to as “Recipient” form to record an individual's name, address and hand written signature
A form herein referred to as “Release of Information” form for member to indicate the conditions required to release the Location form to the recipient.

### BACKGROUND OF THE INVENTION

2. Prior Art

It is widely agreed that if one is to protect one's assets and important documents, in addition to identifying these items, they must indicate their location.

Many financial planners urge people to compile “The List” as a way of establishing just where the family assets and important documents are located. It has also been suggested that one write an annual letter to a spouse or loved one indicating the location of all the assets and important documents. The list and letter approach is not confidential in that it provides the individuals with all the information regarding your assets and important documents at the time you give them the list or letter.

There are forms, commercially sold or home prepared that assist one in recording the location of assets and important documents. This solution requires a personal paper-based filing system for the forms. The forms can be misplaced, lost or destroyed. The location of the forms would in turn require some secrecy to prevent uninvolved individual(s) from coming upon the forms accidentally and yet be available to the appropriate individual at the proper time.

Lawyers have, on occasion, suggested to their clients, that with the preparation of a Will the client should prepare an addendum, indicating where the assets mentioned in the Will are located. This method requires the death of the client prior to disclosing the location of assets. Incapacitation or a medical impairment such as Alzheimer, coma or other memory failure situations would not provide a care giver with the knowledge of the client's assets or their location.

There are safekeeping institutions that will maintain physical control of one's assets and important documents. This method requires frequent visits to the safekeeping institution to access, retrieve, add, delete or change any of the assets or important documents. This method would also require maintaining a record of what was sent to the safekeeping establishment.

With the introduction of the computer, there are a number of institutions available where one can submit asset and important document information to a computerized data base as disclosed U.S. Patent Application Publication US 2002/0111946 to Fallon (2002) and U.S. Pat. No. 5,241,466 to Perry (1993). These systems require a password and/or other means of identification to access the data base. They assume a knowledge of data processing and require an elaborate and time consuming method of data entry, retrieving, changing or editing any of the information entered on the data base is required. As with all computerized applications, computer software and hardware may become obsolete or no longer available or maintained. Breach of security from without is always of major concern in a data processing environment.

In all of the methods and processes enumerated above, the intended receiver of the assets and important documents, either initially or upon the fulfillment of a pre-designated condition, becomes aware of all the details regarding the assets or important documents. This may not be the best situation if the relationship between the individual and the receiver has changed.

### BACKGROUND OF THE INVENTION

Objects and Advantages

There arises a need for a simple method of controlling your assets and important documents by identifying the location of, but not the specific asset and important document. Furthermore, a specific location would be identified only once even if that location contained more than one asset or document.

There exists a need that the identification of the location of asset and important documents be sufficient enough to be ascertained but not specific as to divulge the asset or important document, i.e., The First Bank, 100 Main Street, Any City, USA as opposed to The First Bank, 100 Main Street, Any City, USA checking account no. 100012323.

There exists a need that recipients, of the information regarding the location of assets and important documents, not be made aware of the specific asset or important document. The location information would be sufficient for the concerned individuals having legal rights over the asset or important document to ascertain the specific asset and important document.

Several objects and advantages of my invention are:
(a) provide a form, and an example of a prepared form, to record the location of assets and important documents;
(b) when several assets and important documents are at one location, the location is to be recorded once. Any further itemizing, describing or detailing of the asset or important documents at that location is not required, i.e., a safe deposit box at the First Bank of U.S., Main St; USA, containing jewelry, insurance policies, birth certificates, etc., would be listed on the Location form, as First Bank of U.S., Main St., USA;
(c) the monetary value of any of the assets and important documents are never requested. Member is instructed not to record monetary information on the Location form;
(d) record only the location of the asset or important document; and not the specific asset or important document;
(e) provide form, and an example of a prepared form, to record individuals who will be the recipients of the form listing the location of assets and important documents;
(f) provide form, and an example of a prepared form, to record under what conditions the form listing the location of assets and important documents would be released to the recipients;
(g) When conditions for the release of information are met, and the recipients receive a copy of the Location form, they will only be aware of where the assets or important documents are, but not what they are. For example, if a location is a bank, the information released to the recipient will only list the name and location of the bank. It will not reveal the type of accounts maintained nor their monetary value. Still further objects and advantages will become apparent from the specifications and drawings.

### SUMMARY

This invention provides for a central safekeeping institution to maintain a record of the location of an individual's assets and important documents, with no indication as to what the asset or important document is. The central safekeeping institution also maintains a record of the individual's list of recipients who will receive the Location Form and a list of the conditions upon which this Location Form will be released to the recipients. The Location Form is prepared without indicating any monetary value.

### BRIEF DESCRIPTION OF DRAWINGS

The term Safe Keeping Institution is a hypothetical term used to assist in the description of this invention.

FIG. 1 is a flow chart of a member's application submission and a Safe Keeping Institution's enrollment unit activities upon receipt of the individual's application for membership.

FIG. 2 is a flow chart of the member's completion of the forms and the Safe Keeping Institution's information collection unit activities upon receipt of the member's returned forms.

FIG. 3 is a flow chart of the Safe Keeping Institution's member update unit, activities regarding member-requested changes or updates to their stored information. A flow chart of the Safe Keeping Institution's information retrieval unit, activities in response to recipient's inquiry when the conditions for the release of information have been met.

### DETAIL DESCRIPTION OF THE INVENTION

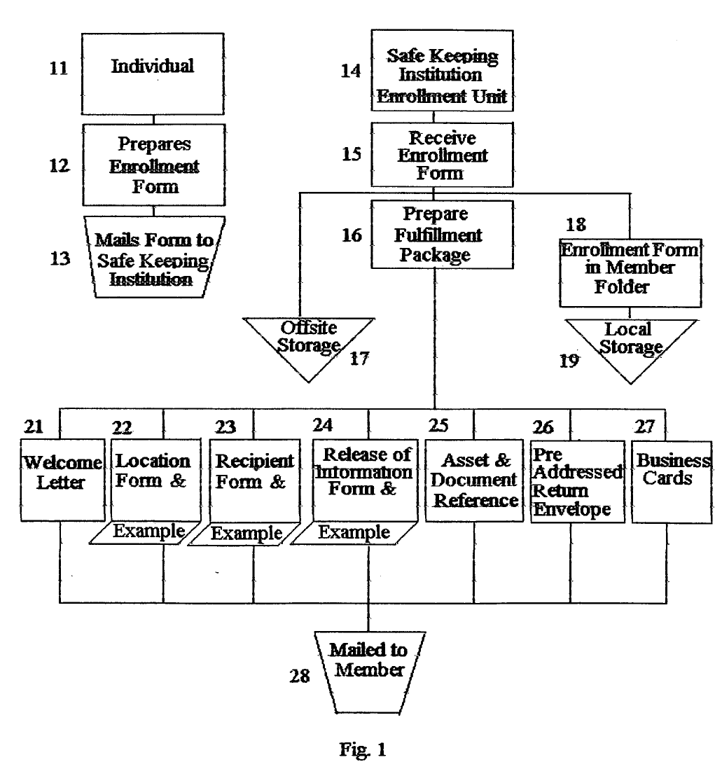

FIG. 1 A individual 11 who becomes aware of the invention, due to a marketing program, a sales promotion, word of mouth, solicitation, or other media coverage, submits an enrollment form 12 for membership to a Safe Keeping Institution 13.

The Safe Keeping Institution enrollment unit 14 upon receipt of an enrollment Form 15 for membership, which is time stamped upon receipt, prepares a Fulfillment Package 16. A copy of the enrollment form is sent to an offsite storage location 17. The enrollment form is placed in a folder 18 titled with member name and number. Member folder is maintained in a local storage facility 19. The fulfillment package includes the following items. A welcoming letter 21 including instructions on completing the accompanying forms. Two Location Forms 22, one form as an example and one blank form to be filled out and returned. Two Recipient Forms 23, one form as an example and one blank form to be filled out and returned. Two Release of Information forms 24, one form as an example and one blank form to be filled out and returned. A list of examples of Assets and Documents 25 to be used as reference in preparing the forms. A pre-addressed return envelope 26 for the return of the above completed forms. A plurality of Safe Keeping Institution's business cards 27 indicating the business logo, name and postal address. These cards are intended as a quick reference source for contacting the Safe Keeping Institution. The fulfillment package 28 is mailed to the member.

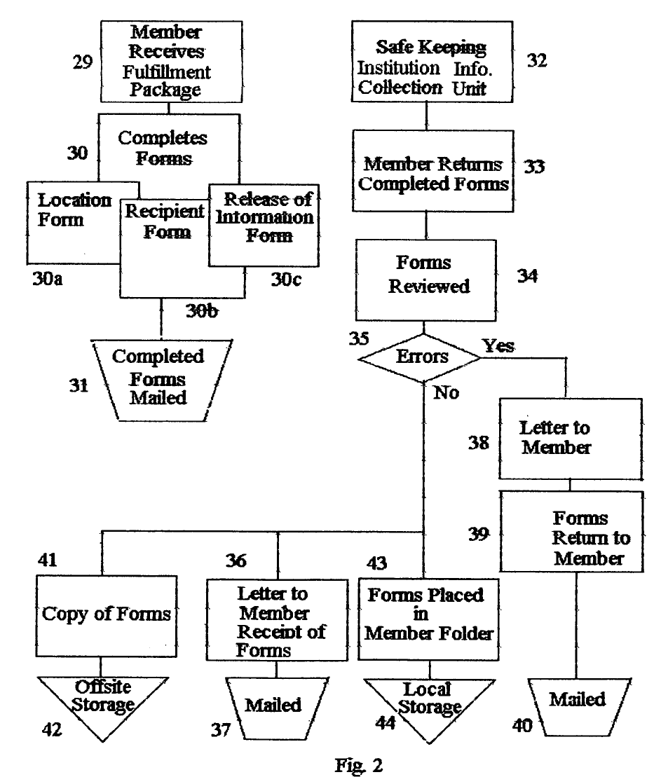

FIG. 2 The member receives the fulfillment package 29. The member completes the Forms 30 and returns the signed forms to the Safe Keeping Institution 31. The Location form 30a, as requested by the instructions and evidenced by the example provided indicates the location of the member's assets and important documents but not the specific asset or document. Once a location is recorded it is not repeated for any other asset or document. Any one location can have one or more assets, as would be the case of a bank's safe deposit box containing jewelry, passport and birth certificate. The identity of the specific asset or document is further maintained by indicating a relationship between the member and the particular bank, but not the existence of a safe deposit box. An illustration of the above example listed on the Location form would be The First Bank, Main Street, USA, with no mention of asset or type of relationship. Similarly, other asset or important document locations could be listed as ABC Brokerage, 100 First Street, USA or Smith Law Office, 22nd Ave., USA. The member is requested not to reveal the monetary value of any asset or important document.

Preparing the Recipient form 30b requires the member to inform the prospective recipient of their participation in this procedure. The member must inform the prospective recipient under what conditions they will be allowed to receive the member's asset and important document Location Form. The member must obtain the recipient's name, address and hand written signature on the Recipient form. The recipient will also receive the Safe Keeping Institution's business card for contact purposes. Being part of this procedure does not bestow upon the recipient any additional legal rights or privileges regarding the member's assets or important documents. The recipient, knowing of a relationship between the member and the financial or commercial institution, is not knowledgeable of the details of the relationship.

The Release of Information form 30c indicates under what conditions the Location form will be released to the designated recipients. The conditions can include, but are not limited to, death, incapacitation, life threatening situations, disaster planning, or, at any time. Conditions for the release of information must be communicated to the Safe Keeping Institution by mail from an authorized recipient. The member can stipulate whether the condition for the release of information exists as stated by a hand signed request from the recipient, or require additional proof such as a death certificate. The condition for the release of information can be stipulated for a lifetime or for a short period of time.

The Safe Keeping Institution Information Collection unit 32 administers the information collection procedure. The member returns completed forms 33. The forms 34 are reviewed for completeness. If the forms are correct 35 a letter 36 acknowledging the receipt of the forms is mailed 37 to the member. If there are errors 35 in the forms, a letter 38 requesting correction of the forms along with the forms 39 are mailed 40 to the member. Copies of the correct forms 41 are made and sent to the offsite storage 42 facility. The original correct forms are stored in member folder 43 in the local storage 44 facility.

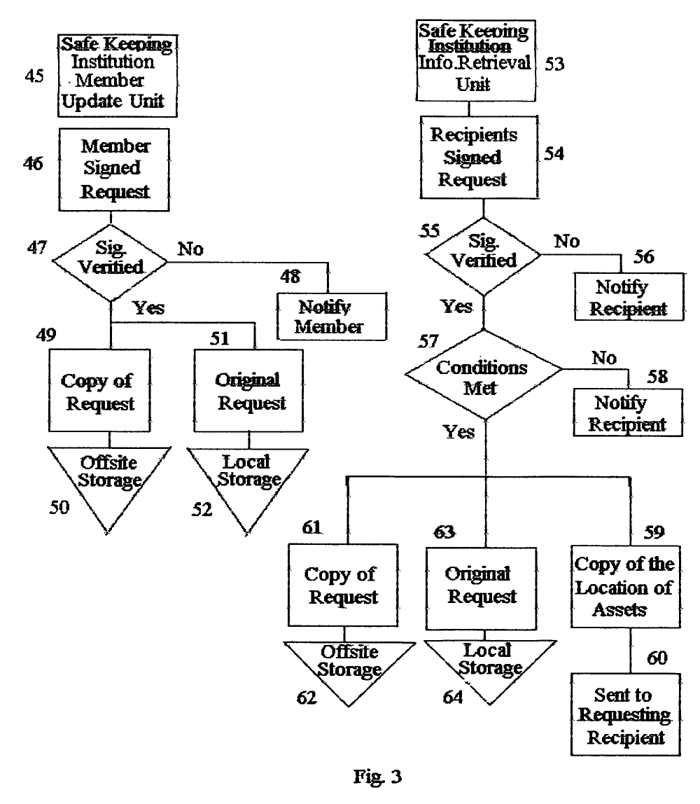

FIG. 3 The Safe Keeping Institution Member Update unit 45 maintains the member information. Member submits a signed request 46 to change or update information on file. The request is time stamped upon arrival. The member's signature is verified 47. If the signature is not correct, the member is notified 48. If the signature is correct, the signed request is copied 49 and sent to the offsite storage 50 The original request 51 is placed in the member folder in the local storage facility 52.

The Safe Keeping Institution Information Retrieval unit 53 fulfills the member's wishes. When the condition exists to receive the information regarding the location of assets and important documents, a recipient must notify the Safe Keeping Institution. The recipient must submit a hand signed request 54 to receive the information. The recipient's signature is verified 55. If the signature is not correct, the recipient is notified 56. If it is concluded 57 that the conditions, for the release of information have not been met, the recipient is notified 58. If the conditions for the release of information 57 have been met a copy of the location of assets and important documents 59 is sent to the requesting recipient 60. Recipient request is copied 61 for offsite storage 62. The original request 63 is stored locally 64.

I claim:

1. A method providing members with the means of protecting their assets and import documents, the method comprising:
organizing and administering the activities for a plurality of members;
receiving, reviewing and storing forms, correspondence and other informational items received from the member,
providing a Location Form for said member to complete and return to the Safe Keeping Institution, said form having spaces in which said member must indicate one or more locations;
providing a Recipient Form for said member to complete and return to the Safe Keeping Institution; indicating the recipients of the Location Form, said form having spaces in which said member must indicate one or more recipient;
providing a Release of Information Form for said member to complete and return to the Safe Keeping Institution indicating under what conditions the Location Form will be available to the authorized recipients, said Release of Information Form having spaces in which said member must indicate one or more conditions;

2. The method of claim 1, further including in the administration of activities, all correspondence be conducted through the United States Postal Service;

3. The method of claim 1, further including in the administration of activities the preparation and delivery to the member a fulfillment package, comprising:
a welcome letter indicating the membership period and instructions on the preparation of the enclosed forms;
an asset and document reference sheet to be used as an aid in the preparation of the enclosed forms;
a pre-addressed return envelope to be used in mailing the forms to the Safe Keeping Institution;
a plurality of business cards, to be used as a quick reference source for contacting the Safe Keeping Institution;
a form to record the location of assets and important documents along with a prepared example of the form for instructional purposes;
a form to identify the recipient of information along with a prepared example of the form for instructional purposes;
a form to identify under what conditions the form with the location of assets and important documents will be released to the recipient along with a prepared example of the form for instructional purposes;

4. The method of claim 1, further including in the administration of activities imprinting, or by other means, affixing a receiving date on all forms and other correspondence items received;

5. The method of claim 1, further including in the administration of activities including the step of placing the forms and other correspondence items in the member's folder and storing the forms locally;

6. The method of claim 5, further comprising the steps of preparing and maintaining a copy of the member's folder at an offsite location;

7. The method of claim 5, further including in the administration of activities, assigning a unique account identifier to each member folder;

8. The method of claim 1, further included in the fulfillment package, wherein only the location of the asset(s) is recorded on the Location Form and not the specific asset nor monetary value;

9. The method of claim 1, further included in the fulfillment package, wherein multiple assets and important documents located at one location require only one location to be recorded on the Location Form; the specific assets and important documents are not recorded;

10. The method of claim 1, further included in the fulfillment package, wherein the location on the Location Form is to be described in general terms but sufficient so that any person of ordinary skill can, with the required authority or by operation of law, ascertain what the asset or important document is at that location;

11. The method of claim 1, further included in the fulfillment package, wherein the member provides on the Recipient Form the name, address and hand written signature of one or more individuals designated as recipient(s);

12. The method of claim 1, further including in the reviewing activities, wherein monetary value of any asset is not to be recorded on the Location Form;

13. The method of claim 1, further including in the administration of activities, notifying members of the arrival of any informational item, form or document;

14. The method of claim 1, further included in the administration of activities, verifying the identity of the recipient when said recipient requests the Location Form;

15. The method of claim 1, further included in the administration of activities, determining that conditions for the release of information have been met;

16. The method of claim 1, further included in the administration of activities, forward to requesting recipient a copy of member's Location Form.
